(19) United States
(12) Patent Application Publication
(10) Pub. No.: US 2002/0132746 A1
(43) Pub. Date: Sep. 19, 2002

(54) Toilet bowl cleaner effervescent tablet

(76) Inventors: Richard A. Desenna, Duluth, GA (US); Hilton G. Dawson, Canton, GA (US); Ryan Griffin Moore, Lilburn, GA (US); Kenneth Scott Wiley, Oakwood, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/051,245

(22) Filed: Jan. 18, 2002

Related U.S. Application Data
(60) Provisional application No. 60/262,483, filed on Jan. 18, 2001.

(51) Int. Cl. C11D 1/00

(52) U.S. Cl. 510/191

(57) ABSTRACT

An effervescent tablet composition for use in cleaning toilet bowls. The tablet composition includes a surfactant and an effervescent system. The effervescent system may include an acid. Further, the effervescent tablet may include a surfactant, binder, lubricant, and/or fragrance. A method of producing a toilet bowl cleaner is also presented, including mixing the starting materials, forming an effervescent tablet and, optionally, packaging the tablet in a moisture-resistant pouch.

### CROSS-REFERENCE TO RELATED APPLICATION

This application claims priority to U.S. Provisional Application Serial No. 60/262,483; filed Jan. 18, 2001.

### TECHNICAL FIELD

The present invention is generally related to toilet bowl cleaners and, more particularly, is related to a method for preparing toilet bowl cleaners in an effervescent formulation.

### BACKGROUND OF THE INVENTION

All toilets found in private residences and public facilities are contaminated by various organic materials that contain or support the growth of various microorganisms. Proper cleaning reduces the level of microorganisms and the organic material necessary to maintain microorganism viability; however, cleaning alone is not sufficient to kill or inhibit the growth of all organisms and use of disinfectants may be desirable.

A disinfectant is a substance that destroys or irreversibly inactivates infectious or other undesirable bacteria, pathogenic fungi, and viruses or surfaces or inanimate objects. Disinfectants kill the growing forms but not necessarily the resistant spore forms of microorganisms. Sterilizers, on the other hand, destroy the growing and spore forms of viruses, bacteria, and fungi on inanimate surfaces. Sanitizers are used to reduce the number of living bacteria or viable virus particles or inanimate surfaces, in water, or in air, and fungicides and fungistats are used to inhibit the growth of or destroy fungi on inanimate surfaces.

The use of disinfectant or sterilant concentrates in a powdered form has been taught in the prior art; for example, in U.S. Pat. No. 5,350,563 to Kralovic et al. The problem with the use of powders as disinfectant concentrates is that they also must be measured in order to prepare the diluted solution and must be poured from one container to another. In addition, there are sometimes problems with forcing the powder into solution.

Important considerations in the selection of a cleaning composition include ease of handling, cleaning ability, high levels of foam or suds which are associated by consumers with cleaning performance and stability of the product during storage. Certain consumers have found concentrated liquid cleaners to be highly desirable. One advantage of liquid cleaners is the ease of handling because liquids can be automatically pumped or dispensed directly to their final use application. Liquid cleaners can also be made into a highly concentrated intermediate aqueous solution that is subsequently flushed/diluted to its proper final use application solution. Liquid cleaners are generally more rapidly soluble than powder or granule cleaners with the same or comparable active ingredients. Liquid cleaners can use higher levels of some surfactants that would cause powders or granules to cake if used at similar levels.

Almost all liquid cleaners have the disadvantage that they are diluted with water, so larger volumes and weights have to be shipped, stored and used to accomplish the equivalent cleaning as a highly concentrated powder or granules. Also, liquid cleaners cannot tolerate high concentration of organic surfactants with dissolved inorganic builders and sequestering agents, with all the ingredients remaining homogenous throughout its shipping and storage. Many liquid cleaners utilize high concentrations of corrosive chemicals which easily spill or splatter on users, causing chemical burns, inhalation burns, blindness or discomfort. Additionally, the ingredients within liquids interact because the ingredient molecules are mobile. These interactions can precipitate or irreversibly inactivate some of the active ingredients upon storage. Furthermore, liquids, for the most part, do not allow a stable, homogeneous solution of surfactants, builders, sequestrants and bleach sources in a product with long term stability upon storage.

One advantage of powder cleaners is the high concentrations of active ingredients because few or no inert ingredients are required. In powder or granules cleaners, high levels of inorganic or organic salts can be used to raise alkalinity and soften water by chelating or sequestering water hardness ions. The powdered cleaners can be used to provide oxidizing agents (bleaches) or reducing agents and granular enzyme materials that can be blended into free flowing powder cleaners. The oxidizing or reducing agents and the enzymes are sufficiently more stable in powdered or granulated cleaners to permit extended storage. A significant disadvantage of powder cleaners for commercial applications is that they are not as accurately controllable in dispensing equipment as liquids may be. Powder systems can require manually scooping a quantity of powder for each use, thus not taking advantage of the ease, accuracy and hands-off labor savings of liquid dispensers. Also, powders can cake if exposed to high humidity or temperatures. Once they become caked, they cannot be subsequently removed from their shipping container. Powders can lose some of their activity if moistened or exposed to high humidity. Non-homogeneous powders can segregate in their shipping containers, i.e., separate or stratify by particle size or density resulting in a non-uniform mixture that may not be appropriate for ultimate use applications. Furthermore, powders can create a safety hazard in that granules or airborne dust particles of irritating or corrosive materials can exit their container or otherwise come in direct contact with living tissue, including lung tissue, causing burns or discomfort.

Other patents, for example, those of Hunt et al., U.S. Pat. No. 4,265,847, and White et al., U.S. Pat. No. 4,536,389, teach effervescent tablets useful for preparing solutions for sterilizing or disinfecting. Such compositions are rapid water soluble tablets typically comprising an active chemical compound, an alkali metal bicarbonate, e.g. sodium or potassium bicarbonate, and a solid aliphatic carboxylic acid such as citric acid, tartaric acid, adipic acid, or an acid salt thereof. In use, such tablets are dissolved in water whereupon the interaction of the bicarbonate and acid components results in the release of carbon dioxide, thus increasing the solubility rate of the other components and producing a solution in which the active (disinfecting) ingredient is homogenously dissolved. Methods for forming effervescent tablets are well known in the art. For example, see U.S. Pat. No. 4,265,847 to Hunt et al. and U.S. Pat. No. 5,114,647 to Levesque et al., which disclosures are incorporated herein in their entireties, by reference.

Halogen compounds are effective as disinfecting agents but their use as such agents is limited due to difficulties in storage, mixing, and handling of concentrated halogens and instability of dilute forms. The use of sodium dichloroisocyanurate as a disinfecting agent is known in the prior art. For example, see U.S. Pat. No. 4,536,389, to White et al., and U.S. Pat. No. 5,114,642, to Levesque et al. Sodium dichloroisocyanurate hydrolyzes in water to produce hypochlorous acid (HOCl) and hypochlorite (OCl⁻), which exist in solution at an equilibrium that is dependent upon the pH of the solution. For example, at neutral pH a solution may consist of about 75% hypochlorous acid and 25% hypochlorite. The prior art teaches the use of bromide as a disinfectant, where the hypobromous acid and hypobromite species are produced in solution typically by the use of bromo, chloro-5,5-dimethylhydantoin. The hypohalous acid species is the antimicrobial form of the above compounds, with the hypohalite having some antimicrobial effect. However, the negative charge of the hypohalite inhibits its diffusion through the cell wall for microorganisms and thus lowers its antimicrobial effect.

Thus, a heretofore-unaddressed need exists in the industry to address the aforementioned deficiencies and inadequacies.

### SUMMARY OF THE INVENTION

The present invention involves a cleaner that effectively cleans toilet bowls. It is produced in tablet or granular form, which overcomes many of the problems described above with liquid and powder cleaners. By being packaged in a tablet or granular form, the toilet bowl cleaner of the present invention, is pre-measured and easy to dispense, with very little risk of accidental inhalation or skin exposure. Further, the toilet bowl cleaner of the present invention may come in prepackaged in moisture-impervious pouches that clean exactly one toilet bowl per tablet, thus rendering it safe and easy to use. Additionally, the toilet bowl cleaner of the present invention also produces a significant amount of foam, i.e., at least one inch above the water line of the toilet, which further aids in cleaning of the toilet bowl.

The toilet bowl cleaner includes at least one surfactant and an effervescent system. The effervescent system should be such that a significant level of foam is produced in the toilet bowl. Optionally, the toilet bowl cleaner may also include a disinfectant, one or more enzymes, a binder, a lubricant, and/or a fragrance.

The present invention can also be viewed as providing methods for producing a toilet bowl cleaner. In this regard one embodiment of such a method, among others, can be broadly summarized by the following steps: blending starting materials which include a hypochlorite generator, an effervescent system, and a surfactant; blending a lubricant into the blended starting materials; and forming an effervescent tablet from the blended starting materials and lubricant. An additional embodiment includes compacting and milling the blended lubricant and starting materials into granules instead of forming the cleaner into tablets. This method of producing the granules may also include a step of classifying the granules by size, and then packaging the granules of the desired size into moisture-resistant packages that may optionally be pre-measured to clean exactly one toilet bowl.

Other features, methods, and advantages of the present invention will be or become apparent to one with skill in the art, upon examination of the following detailed description. It is intended that all such additional features, methods, and advantages be included within this description, be within the scope of the present invention, and also be protected by the accompanying claims.

### DETAILED DESCRIPTION

There is a need for an effective toilet bowl cleaner packaged and supplied in a convenient effervescent form. The effervescent tablet or granules must fully and rapidly dissolve in a rapid fashion to form a homogeneous cleaning solution that is highly active and stable for a useful length of time, as well as produce a sizeable amount of effervescent foam. It has been heretofore unknown in art how to produce a toilet bowl cleaner in tablet or granular form that can dissolve in less than five minutes, and produce significant effervescent foam in the toilet bowl.

The present invention provides a non-liquid toilet bowl cleaner in a tablet or granular form and method of preparing the cleaner in both tablet and granular form. The toilet bowl cleaner may be packaged in a single application atmospheric-resistant pouch. The single application pouch provides a convenient, compact, and safe way to keep and store this toilet bowl cleaner. To activate the toilet bowl cleaner, the cleaner may be placed directly into the toilet bowl. Generally, single application pouches contain a pre-measured amount of cleaner to clean a standard 1.5-liter toilet bowl. In a preferred embodiment, the cleaner dissolves in the water in less than 5 minutes. Cessation of effervescence is an indicator that the cleaner has dissolved. The effervescent foam level is approximately one inch above the water line in the toilet bowl in a preferred embodiment.

The toilet bowl cleaner should be carefully prepared, stored, and packaged to prevent moisture from initiating premature decomposition of the cleaning components and thus rendering it less effective. The toilet bowl cleaner is preferably produced in a moisture-controlled atmosphere in order to inhibit the active ingredients from absorbing moisture from the air. Thus, proper preparation and packaging of the toilet bowl cleaner may decrease the possibility of premature decomposition.

The toilet bowl cleaner includes at least one surfactant and an effervescent system. Additionally, at least one disinfectant, enzyme, binder, lubricant, bleaching agent, and fragrance can be included in the toilet bowl cleaner as optional ingredients.

The disinfectant may be a hypochlorite generator which may include, but is not limited to, one or more of the following: chlorinated isocyanurates and alkaline earth metal hypochlorites. More particularly, the hypochlorite generator used is typically an anhydrous form of dichloroisocyanurate. The hypochlorite generator represents from approximately 0.1% to approximately 20% by weight of the total weight of the toilet bowl cleaner.

The effervescent system is composed of one or more of an alkali metal carbonate and an acid. The alkali metal carbonates may be selected from, but not limited to, the following: sodium carbonate, sodium bicarbonate, and/or potassium carbonate. More particularly, sodium and potassium bicarbonate are used as the alkali metal carbonate. Furthermore, one or more acids may be selected from, bit is not limited to, the following: citric; maleic; fumaric; adipic; potassium or sodium phosphate, monobasic; oxalic; lactic; sulfamic; tataric acid; sodium bisulfite; sodium bisulfate; and/or sodium or potassium pyrophosphate. In a preferred embodiment, citric acid is used as the acid. The effervescent system, the summation of the alkali metal carbonate and the acid, may represent from approximately 20% to approximately 90% by weight of the total weight of the toilet bowl cleaner.

It should be noted that scale and rust removal in a toilet bowl may be accomplished by the toilet bowl cleaner by using an effervescent system that includes sodium bisulfate and sulfamic acids as the acid components. The pH of the toilet bowl cleaner that incorporates these ingredients in the effervescent system may range from approximately 1.6 to approximately 2.2. Other acids may be used, but generally will not give the low pH desired to accomplish rust and scale removal.

Furthermore, the toilet bowl cleaner may include a lubricating agent, which limits clinging of the cleaner to the surface of the toilet bowl. The lubricant that may be used can be selected from, but is not limited to, the following: sodium benzoate, stearates, mineral oil, silicates, and/or algenic acid. In a preferred embodiment, sodium benzoate is used as the lubricating agent. The lubricant may represents up to approximately 10% by weight of the total weight of the toilet bowl cleaner.

In addition, the toilet bowl cleaner may include a binder. The binder that may be used can be selected from, but is not limited to, the following: polyethylene glycol, sorbitol, maltodextrin, and/or sugars (e.g., lactose, sucrose). In a preferred embodiment, sorbitol and polyethylene glycol are used as binders. The binder may represents up to approximately 20% by weight of the total weight of the toilet bowl cleaner.

Additionally, the toilet bowl cleaner may include a surfactant mixture. The surfactant mixture may include, but is not limited to, alkylated, sulfonated diphenyl oxide; disodium salt; sodium lauryl sulphate; and/or alkyl benzene sulfonates. The surfactant mixture of the preferred embodiment includes a C₁₂₋₂₀ ethoxylated alcohol, preferably the surfactant Rhodosurf™ TB970; and a sodium C₁₄₋₁₆ olefin sulfonate, preferably Bioterge™ AS90. The surfactant may represent approximately 0.1-5% by weight of the total weight of the toilet bowl cleaner.

An optional enzyme or combination of enzymes may be included in the cleaner. One function the enzyme may serve is to improve cleaning performance by hydrolysis of some bio-films, which include polysaccharides produced by microorganisms. The enzymes that may be used in the toilet bowl cleaner, include but are not limited to, any one or combination of the following types: cellulase, protease, and lipase. The cellulase may be in the form of a cellulase complex containing several polysaccharide degrading enzymes. In a preferred embodiment, the cellulase complex may include significant levels of endo-cellulase, exo-cellulase, cellobiase, xylanase, pentosanase, polygalacturonase and beta-glucanase. One skilled in the art can envision equivalents of these enzymes that may be also be effectively used in the toilet bowl cleaner. In the preferred embodiment, enzymes comprise from approximately 0.1% to approximately 1.0% by weight of the toilet bowl cleaner composition.

A bleaching agent may be added to the toilet bowl cleaner to aid in whitening and cleaning of the toilet, as well as sanitizing. A perborate such as sodium perborate may be added to the toilet bowl cleaner to provide oxygen bleaching or a hypochlorite generator such as chlorinated isocyanurates or alkaline earth metal hypochlorites may be added to provide chlorine bleaching.

Table 1 below lists the ingredients of the preferred embodiment of the invention, as well as the weight percent of each ingredient. It should be noted that the following Table 1 merely represents one possible embodiment and composition of the cleaner and that the cleaner is in no way limited to this exact composition.

TABLE 1
Ingredients of the Preferred Embodiment

| | Approximate |
|---|---|
| Ingredient | Weight Percent (%) |
| Citric Acid (fine granular) | 30.6 |
| Sodium Bicarbonate | 45.0 |
| Potassium Bicarbonate | 5.0 |
| Carbowax 8000 ™ | 5.0 |
| Sorbitol | 9.9 |
| CDB | 1.7 |
| Sodium Benzoate | 2.0 |
| Bioterge ™ | 0.2 |
| Rhodasurf ™ | 0.07 |

Table 2 below is an exemplar toilet bowl cleaner composition. As with Table 1, this is merely set forth as one embodiment of the toilet bowl cleaner. The cleaner is not limited to these ingredients, which may not be included in other embodiments, nor is the cleaner limited to the ranges of percentage compositions set forth in Table 2, but may instead include different ranges of percentage compositions.

TABLE 2
Ingredients of Exemplar Embodiment

| | Approximate |
|---|---|
| Ingredient | Weight Percent (%) |
| Sodium bisulfate | 25-45 |
| Sodium bicarbonate | 20-40 |
| Sulfamic Acid | 15-25 |
| Sorbitol | 7-12 |
| Polyethylene glycol | 3-8 |
| Sodium benzoate | 1.5-2.5 |
| Sodium perborate | 0.25-1.25 |
| Enzymes | 0.25-1.25 |
| Surfactant | 0.25-1.25 |
| Color | 0.05-0.5 |

The present invention also relates to the method of producing the toilet bowl cleaner in tablet form. The method first involves adding all of the ingredients in Table 1, except for sodium benzoate, to a V-, or Hobart, blender and blended preferably for at least approximately 20 minutes. Sodium benzoate is then added, and the mixture is blended for approximately three to four minutes, pressed into tablets, optionally packaged in individual moisture-impervious pouches, and then optionally boxed for shipment.

The present invention also includes a method of producing the toilet bowl cleaner in granular form. The method first involves adding all of the ingredients in Table 1, except for sodium benzoate, to a V-, or Hobart, blender and blended for at least approximately 20 minutes. Sodium benzoate is then added and the mixture is blended for approximately three to four minutes. The ingredients are then placed in a granulator unit that compacts and mills the ingredients into granules. The granules may then be optionally passed over a classifier, after which the granules of the desired size may optionally go into moisture-impervious pouches. Many different types of granulator units may be used to produce the granules of the present invention. The granulator may be for example, but is not limited to, a roll compactor or an extruder-type of granulator.

It should be emphasized that the above-described embodiments of the present invention, particularly, any “preferred” embodiments, are merely possible examples of implementations, and are merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A toilet bowl cleaner comprising:
a surfactant; and
an effervescent system including an acid, wherein the effervescent system produces a significant level of foam in a toilet bowl; and
wherein the cleaner has a pH from approximately 1.6 to approximately 2.2.

2. The composition of claim 1, wherein the effervescent system further comprises a hypochlorite generator.

3. The composition of claim 1, wherein the acid comprises:
sulfamic acid; and
sodium bisulfate.

4. The composition of claim 2, wherein the hypochlorite generator comprises from approximately 0.1% to approximately 20% by weight of the composition.

5. The composition of claim 2, wherein the hypochlorite generator is chosen from at least one of: chlorinated isocyanurates, alkali metal hypochlorites, and alkaline earth metal hypochlorites.

6. The composition of claim 4, wherein the chlorinated isocyanurate is dichloroisocyanurate.

7. The composition of claim 4, wherein the alkali metal hypochlorite is chosen from at least one of: lithium hypochlorite, magnesium hypochlorite, and calcium hypochlorite.

8. The composition of claim 1, wherein the effervescent system comprises from approximately 20% to approximately 90% by weight of the composition.

9. The composition of claim 1, wherein the effervescent system further comprises:
an alkali metal carbonate; and
an acid.

10. The composition of claim 9, wherein the alkali metal carbonate is chosen from: sodium carbonate, sodium bicarbonate, potassium carbonate, and potassium bicarbonate.

11. The composition of claim 9, wherein the acid is chosen from at least one of: citric; maleic; fumaric; adipic; potassium phosphate; sodium phosphate, monobasic; oxalic; lactic; sulfamic; tataric; sodium bisulfite; sodium pyrophosphate; and potassium pyrophosphate.

12. The composition of claim 1, wherein the level of foam is approximately one inch above a water line in the toilet bowl.

13. The composition of claim 1, further comprising at least one of:
an enzyme;
a binder;
a lubricant; and
a fragrance.

14. The composition of claim 13, wherein the surfactant is chosen from at least one of: alklyated, sulfonated diphenyl oxide; disodium salt; sodium lauryl sulphate; and alkyl benzene sulfonates.

15. The composition of claim 13, wherein the surfactant comprises a mixture of a C₁₂₋₂₀ ethoxylated alcohol and a sodium C₁₄₋₁₆ olefin sulfonate.

16. The composition of claim 13, wherein the surfactant comprises approximately 0.1% to approximately 5% by weight of the composition.

17. The composition of claim 13, wherein the binder comprises up to approximately 20% by weight of the composition.

18. The composition of claim 13, wherein the binder is chosen from at least one of: polyethylene glycol, sorbitol, maltodextrin, and sugars.

19. The composition of claim 13, wherein the lubricant comprises up to approximately 10% by weight of the composition.

20. The composition of claim 13, wherein the lubricant is chosen from at least one of: sodium benzoate, stearates, mineral oil, silicates, and algenic acid.

21. The composition of claim 13, wherein the enzyme comprises from approximately 0.1% to approximately 1.25% by weight of the composition.

22. The composition of claim 13, wherein the enzyme is chosen from at least one of: a cellulose, a protease, and a lipase.

23. The composition of claim 13, wherein the enzyme is chosen from at least one of: endo-cellulose, exo-cellulose, cellobiase, xylanese, pentosanose, polygalacturonese, and beta-glucanase.

24. A method of producing a toilet bowl cleaner, comprising:
blending starting materials; and
forming an effervescent tablet from the starting materials.

25. The method of claim 24, wherein the starting materials comprise:
a surfactant; and
an effervescent system including an acid,
wherein the starting materials have a pH from approximately 1.6 to approximately 2.2.

26. The method of claim 24, wherein the starting materials further comprise at least one of:
a binder; and
a fragrance.

27. The method of claim 24, further comprising blending a lubricant into the starting materials.

28. The method of claim 24, further comprising packaging the tablet in a moisture-resistant pouch.

29. The method of producing a toilet bowl cleaner, comprising: blending starting materials comprising
a surfactant and
an effervescent system including an acid,
wherein the starting materials have a pH from approximately 1.6 to approximately 2.2;
blending a lubricant into the blended starting materials;
compacting and milling the blended lubricant and starting materials into granules;
classifying the granules by size; and
packaging the granules of a desired size into moisture-resistant packages.
